(19) United States
(12) Patent Application Publication
(10) Pub. No.: US 2005/0058814 A1
(43) Pub. Date: Mar. 17, 2005

(54) Lay flat business form product from discontinuous and differential substrates with removable elements

(76) Inventor: Jesse D. Crum, Fort Scott, KS (US)

Correspondence Address: WARD KRAFT, INC., P.O. BOX 938, FORT SCOTT, KS, 66701, US

(21) Appl. No.: 10/663,131

(22) Filed: Sep. 16, 2003

(51) Int. Cl. B32B 3/00

(52) U.S. Cl. 428/195.1

(57) ABSTRACT

The present invention relates to a discontinuous business form construction created from differential substrates that has been provided with one or more removable elements such as cards, labels, tags and differential substrates. The form construction is desirably a composite form having at least first and second discrete portions one of which carries one or more removable elements and the other of which provides an information carrying portion. The form construction of the present invention is produced in such a manner so that when a series of the forms are placed into a stack, such as in a tray that supplies forms to a printing station or a laser printer, there is no significant pad lean or distorted stack arrangement. That is, the stack of forms retains a relatively square, rectangular or cube shaped as opposed to one having a sloped configuration, a high end and a low end, due to differential thicknesses between the two portions of the construction. In addition, the form construction of the present invention enables the feeding of a form along the long side or in the landscape position and reduces the surface affinity between the forms.

### CROSS-REFERENCES TO RELATED APPLICATIONS

None.

### FIELD OF THE INVENTION

The present invention relates to a discontinuous business form construction created from differential substrates that has been provided with one or more removable elements such as cards, labels, tags and differential substrates. The form construction is desirably a composite form having at least first and second discrete portions one of which carries one or more removable elements and the other of which provides an information carrying portion. The form construction of the present invention is produced in such a manner so that when a series of the forms are placed into a stack, such as in a tray that supplies forms to a printing station or a laser printer, there is no significant pad lean or distorted stack arrangement. That is, the stack of forms retains a relatively square, rectangular or cube shaped as opposed to one having a sloped configuration, a high end and a low end, due to differential thicknesses between the two portions of the construction. In addition, the form construction of the present invention enables the feeding of a form along the long side or in the landscape position and reduces the surface affinity between the forms.

### BACKGROUND OF THE INVENTION

Information carrying structures such as business forms with removable cards, tags and labels have long been used to convey information to the holder, presenter or recipient of the business form. When utilizing removable cards, such cards include but are not limited to insurance, medical, identification (ID cards), membership applications, admissions, tickets, collections, special events, credit or debit cards, temporary passes and the like.

One traditional means used to deliver cards was to place the card in a carrier that had cut out notches to receive two or more corners of the card and then deliver the card through the mail, by use of a courier or by such other means in order to place the card in the possession of the intended recipient. However, while effective in delivering the card to the end user, the process of assembling the mailing could be cumbersome in that it required the carrier to be printed and then to subsequently cut notches in the carrier to create areas to hold the corners of the card and then, finally placing of the card in the carrier. Next, the carrier was typically folded and then usually placed in an envelope prior to mailing the card to the recipient. In addition to being a somewhat cumbersome manufacturing process, the process itself can be expensive, in that it requires a number of pieces, a supply of cards, carriers and envelopes. Thus, there has been a continuing trend to move away from such processes and reduce the number of separate components and steps required to prepare such a business form construction.

Another means by which to deliver cards that arose out of the need to reduce such processing complexities as discussed above was to simply affix the card to the top surface or uppermost portion of the sheet of paper or the like. This product configuration eliminated the need to die cut notches in the carrier to create an area to receive the card as well as the step of having to align and place the corners of the card within the cut out area of the carrier.

In this construction, where the card rides on top of the surface of the substrate, the card was normally affixed to the sheet of paper through the use of a spot adhesive that would hold the card in place during handling and transport, yet allow the card to be readily removed by the recipient. Alignment was not a critical concern and hence processing speeds improved. However, this construction, while eliminating some of the drawbacks associated with the above mentioned arrangement of putting a card into a carrier assembly, still suffered from unforeseen difficulties and created new problems in that the card was placed on the surface of the sheet of paper which then created a raised area that often resulted in jamming of the printer or feeding apparatus when attempting to image or process the paper substrate with the card attached. Unfortunately, while this particular construction resulted in manufacturing efficiencies it created difficulties for the end users as such product configurations had to be carefully or even gingerly fed through the printer, again slowing distribution to the end user and resulting in significant frustration of the end user or printer of the form construction.

In a still further effort to overcome the above-mentioned problem of differential thicknesses created by the inclusion of the card on the surface of the paper or substrate, manufacturers then sought to create holes, pockets or die cut areas in a substrate that corresponded in size and shape to the card that was to be placed into the receiving area. In such a construction, when the card was placed into a receiving area, the card would not rest above the level of the surface of the paper substrate, but instead may extend below the bottom surface of the sheet of paper. Once again the manufacturer, while solving the problem of having the card extend above the surface of the sheet, faced the problem of alignment and having to carefully position the card within the receiving area.

In addition to alignment, the manufacturer also had to hold and secure the card in the receiving area. As such and in order to hold the card in place in the carrier, another web of material was affixed over the hole in the form of a patch, a continuous strip that ran edge to edge or segments of material that would hold the card in position, see for instance U.S. Pat. No. 5,403,236. While effective in over coming the problem with the card being placed on top of the substrate, such a construction then suffered from additional problems.

The addition of the supplemental material over the area of the cut out to receive the card again created a raised portion that extended either below the surface of the paper or alternatively both above and below the surface of the paper, depending upon the thickness of card structure. Again, the construction could still only be fed in a small amount to the printer as the area of double thickness around the card area created a hump, or a sloped configuration when several card carrying sheets were placed in a stack. This limited the amount of cards that could then be placed in the tray to be fed to the printer or processing equipment.

A still further solution to the above-mentioned dilemma was to create a calendared area or recess in the paper substrate, by crushing an area of the paper that corresponded to the size of the card. Then place the card within the substrate. This eliminated the need to apply a patch to hold the card in the area of a cut out into which a card would be inserted; however, this construction still suffers from other drawbacks. The thickness of the card material is still more than the thickness of the paper substrate. As such, the top surface of the card would still be above the top surface of the paper substrate leading to an arrangement that still suffered from difficulties in processing the card due to the differential thickness arising out of the card sticking out of the well or recessed area. In addition, the manufacturer still had to accurately align the construction so that it would fit within the area of the recess or well.

A still further business form and card construction was then contemplated to eliminate the need to align and place a card, usually plastic, in a well, recess, die cut area, etc. This solution was to simply affix a web of card material, again usually plastic, to the substrate. This enabled the manufacture to die cut the material directly in line with the imaging of the information carrying portion of the construction. However, such constructions while attractive from a manufacturing perspective also did not completely solve the processing of the form construction.

The web of card material still needed to be connected to the portion or web of information carrying material. In one arrangement, one web is affixed or partially juxtaposed directly onto an edge or side of the other portion by adhesive, crimping, mechanical fastening or the like. As expected however, this arrangement creates a bump in the form and contributes again to processing difficulties in attempting to feed the construction through the printer. Again, such arrangements had to be carefully processed through the printer and only a few forms at a time could be stacked into a feed tray for a printer or processing equipment.

An attempt to resolve the problem of the discontinuous surface area was to place the webs next to or adjacent one another and then place a small strip of material, such as tape to connect the two webs together. While this solved some additional problems for card manufacturers and end users, still other problems persisted. The area covered by the strip of tape creates a zone having a higher thickness than the rest of the configuration. This again creates problems of feeding the construction through the printer. In addition, the use of two different types of materials, the card material may also be thicker than the information portion of the substrate and as such when the products are placed into a stack they then again create a sloped arrangement, thus limiting the number of cards that can be placed in a feed tray for a printer.

A still further difficulty encountered by such two part constructions is that the web of card material, typically a plastic or synthetic film, may build up excess static when placed in a stack thus making feeding of the forms difficult as they tend to stick to one another in the tray or other feeding mechanism.

In addition to the foregoing enumerated drawbacks of these prior art constructions, modifications were also attempted with respect to the processing or printing equipment, more specifically to the feed trays in order to compensate for the pad lean or slope of the stack of products. Such modifications to the feed trays included the insertion of shims under one portion of the form structure, the form having the lesser thickness (that end without the card) in order to facilitate feeding of the forms. This modification led to more exotic configurations of feed trays including spring loaded and adjustable shims in order to accommodate differing types of form products. However, while the modifications to the equipment appeared to address the problem of pad lean, it nonetheless required the end user or printer to make sure that the appropriate tray, shim, or adjustment had been made to the equipment prior to beginning run of the product. In those situations where the operator forgot to make the equipment change then, the finishing process was subjected to further delays and jamming as indicated above. Moreover, many end users or printers were simply unwilling to make the additional investment in such modified trays.

An additional processing problem also resulted form the use of such prior art constructions. Such constructions, due to the difficulty in feeding the forms, required the forms to be fed in a portrait arrangement into the printer, that is in connection with a form size of 8½″ by 11″, the 8½″ side was fed to printer first. By feeding the short side of the form into the printer first, the printer, which calculates wear of the print head based on the total running length of the print job, was subjected to additional wear in running a regular pass of product as opposed to being able to run a regular pass of forms when fed in a landscape, or long side first, arrangement through the printer. As can be expected, this also resulted in a further delay in processing the forms by the end user or printer.

What is needed therefore, is a business form card combination that overcomes the foregoing difficulties, such as pad lean or sloped stacks, static buildup and other problems so that larger numbers of cards can be placed in a feed tray as well as the problem of bump or humps in the form construction is mitigated and the cost of manufacture is reduced so that the construction can be produced economically as well as expeditiously.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention pertains to a business form carrying one or more removable elements in a relatively homogenous assembly. The construction of the present invention through the use of several leveling aids enables the business form element combination to lay substantially flat in a tray or stack prior to being fed to a printer or other processing equipment for further handling. As such, the business form of the present invention can be fed to a printer in a landscape or long side or edge first format, thereby speeding processing time of the order.

In one embodiment of the present invention a business form is described and includes a first substrate having a first property and having first and second longitudinal side edges and first and second transverse end edges. The business form assembly also includes a second substrate having a second property and the second substrate is joined to the first substrate along one of the side or end edges. The business form assembly also includes at least one removable element from one of the first and second substrates. In addition, the business form assembly also includes a plurality of patterns disposed between one of the sides or end edges of at least one of the first and second substrates, the plurality of patterns is applied to at least one of the first and second substrates and the plurality of patterns spaced from one another. At least one of the plurality of patterns connects the first substrate to the second substrate. The business form card assembly with its plurality of patterns and the first and second substrates create a substantially planar business form assembly having at least one removable element.

In a still further embodiment a method of communicating the benefits of a business form having a removable element assembly, is described and includes the steps of initially producing a number of business form assemblies having a removable element, with the assemblies having at least first and second portions. The first and second portions have different thicknesses. One of the first and second portions having at least one removable element that creates at least a portion of the different thickness and each of the first and second portions having a pattern of material disposed thereon to create a substantially planar business form assembly so that when placed in a stack with other business form assemblies having a removable element, the stack will have a square, cube or rectangular configuration. Next, marketing collateral is created with respect to using the business form assemblies. The business form assemblies are then sold in connection with the marketing collateral to customers or end users and then the business form assemblies are distributed.

In a yet still further embodiment, a business form card assembly, is described and includes a substrate having first and second portions, with the first and second portions being joined one to another through a first pattern of material applied along an edge of each of the first and second portions. One of the first and second portions has a second pattern of material disposed thereon and spaced from the first pattern. At least one removable element is contained within one of first and second portions, with the removable element having a different thickness than at least one of the first and second portions. The first and second patterns cooperating with the removable element to form a substantially coplanar form assembly. The first and second portions with the removable element and the first and second patterns of material are connected to additional business form card assemblies to create a continuous business form arrangement having a removable element. The continuous business form arrangement is then wound on itself to form a roll of business form assemblies with at least one removable element.

In a still further embodiment a stack of business form assemblies with at least one removable element creating a different thickness in the business form assembly, is described and includes a plurality of business form assemblies, each of the assemblies having a first and second portions joined to one another by a first pattern of material and one of the first and second portions having at least a second pattern of material to create a substantially planar assembly. The plurality of business assemblies form with the removable element and the first and second patterns of material forms a square, cube or rectangular shaped stack ranging from 10 to about 10,000 assemblies.

The present embodiments are intended to be exemplary illustrations of the present invention and it should be understood that the invention is capable of other configurations within the scope of the specifications provided herein.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a rear view of the present invention showing the position of an exemplary card format and use of a plurality of patterns suitable for use in creating the lay flat construction of the present invention;

FIG. 1A shows a front view of the form assembly in an exemplary embodiment and including a pressure sensitive label in addition to the removable element;

FIG. 2 illustrates a further embodiment of the present invention and provides an alternative pattern configuration used in creating the lay flat business form card assembly of the present invention;

FIG. 3 provides a still further depiction of the patterns used to provide for the lay flat assembly of the present invention and includes differential geometric patterns and positioning;

FIG. 4 shows a side view of the present invention and the plurality of spaced patterns used in creating the lay flat assembly of the present invention;

FIG. 4A depicts a prior art arrangement of business form card combinations shown in a stacked configuration having a sloped arrangement;

FIG. 4B illustrates the business form card construction of the present invention in a stacked configuration as would appear in a tray for a printer and illustrating the relatively square, rectangle or cube shape of the present invention;

FIG. 5 provides a further arrangement of the present invention showing a different card configuration;

FIG. 6 depicts the business form card assembly of the present invention in a continuous or rolled configuration; and

FIG. 6A shows a enlarged cut away portion of the roll configuration and a rear view of the form assembly.

### DETAILED DESCRIPTION OF THE INVENTION

The present invention is now illustrated in greater detail by way of the following detailed description, but it should be understood that the present invention is not to be construed as being limited thereto.

Surprisingly, it has been found that through the use of leveling aids, such as a plurality of patterns, business form combinations with removable elements having a thickness different than that of the rest of the business form can be produced to overcome the foregoing difficulties and can be manufactured in an economical and efficient manner.

The term “patterns” as used herein refers to continuous strips, lines, shapes, spots or elements, discontinuous segments, spots, shapes or elements as well as regular and irregular placement of such items. Patterns may also refer to combinations of the above mentioned items such that one pattern may be a continuous strip, another segmented elements and a still further an irregular placement of dots or the like. Any combination of patterns is possible depending on the desire of the manufacturer or the end user. In additions, the patterns can be prepared in order to accommodate a particular theme, season, event, trade dress, and the like.

The patterns applied to one portion of a form may have a different property, thickness or composition than another pattern of material applied to a different portion of the form assembly. For example, a 1 mil thick material may be applied to a portion of a substrate having a thickness of 5 mils whereas a second portion of the form having a thickness of 3 mills may require a 3 mil thick material to create the necessary leveling of the form in order to create a coplanar configuration.

The patterns may be formed from strips, segments, dots, geometric elements of material such as glassine, machine glazed paper, highly calendared paper and the like as well as from coatings, (wax and starched based) inks and other materials which generally do not adhere sheets together when the sheets are placed in a stack. It is also desirable that the material, coating or inks are selected so that they reduce surface affinity between the sheets, thereby enabling the sheets to release from the stack readily and facilitate the feeding and handling of the sheets by the printer or processing device.

Where machine glazed, highly calendared sheets, glassine or the like materials are used, the material is adhered to each of the substrates typically through the use of adhesives, including but not limited to cold glues, hot melts, acrylics and other suitable adhesive or cohesives that have sufficient bonding strength to secure the material to the form assembly. The adhesive or cohesive used to secure the material to the substrate may be applied by flood coating, pattern or spot coating, transfer coating or other means known in the industry. The coating may be the full length and width of the material or may be applied so that the edges of the material extend slightly beyond the pattern of adhesive laid down.

The term “leveling aid” is used to refer to a plurality of patterns that enable the business form, removable element combination to lay generally or substantially flat, either in a single sheet arrangement or in a stacked configuration such as is used or placed in a tray in order to feed the business form, removable element combinations into a printer or other processing equipment. The leveling aid or aids offset the differential thicknesses that exist between the removable element, first and second portions of the form or any or all of these. The leveling aid or aids may be provided or applied in varying thicknesses or coat weights to offset the differential thicknesses of the form assembly.

The term “plurality” as used herein refers to more than one pattern applied to the substrate to facilitate the leveling of the form assembly. That is, the patterns are used to create an assembly that is substantially planar when several business form assemblies are placed in a stack such as is used in connection with a feed tray or the like.

A “stack” as used herein refers to a stack of individual assemblies or sheet and may range from 10 to 10,000 sheets or assemblies in a stack.

The term “removable elements” refers to items such as cards, labels, chips, coins, tags and the like as well as portions of substrates that have a differential thickness compared with the remainder of the business form to which it is attached, connected or otherwise configured in arrangement therewith and may be removed form the form assembly.

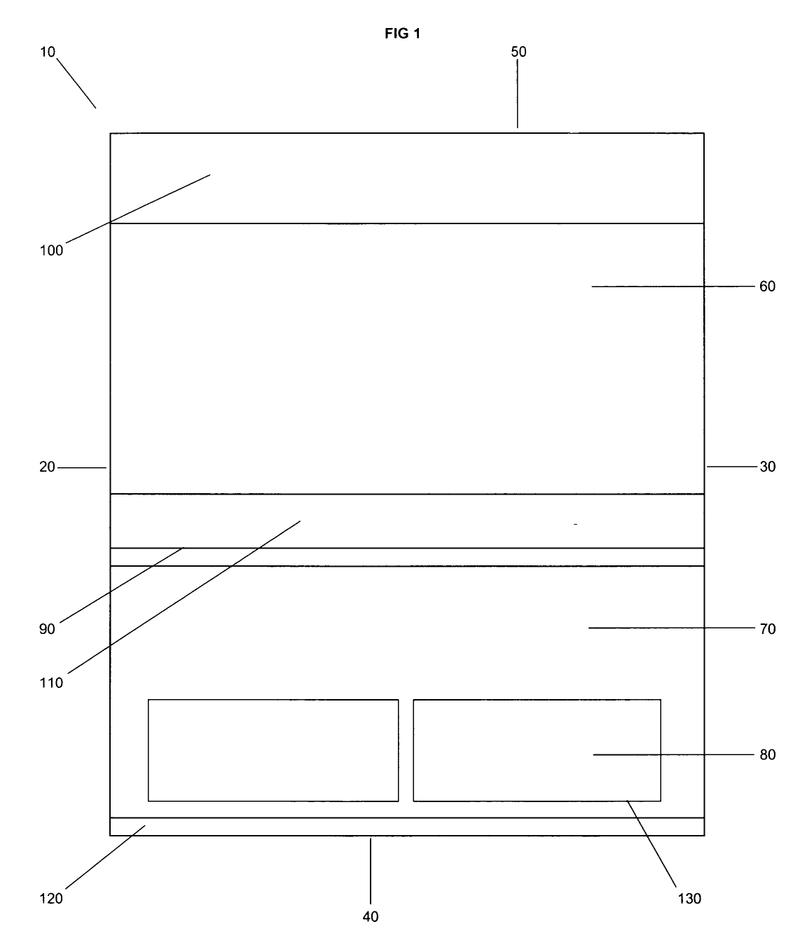

Turning now to FIG. 1 of the present invention, the business form card assembly is generally depicted by reference to numeral 10. As shown in FIG. 1, the back side of the business form card assembly 10 is provided. The business form card construction has first and second longitudinally extending side edges 20 and 30, and first and second transversely extending end edges 40 and 50. The business form card assembly 10 has a first face (shown but not designated by a reference numeral) and a second face (shown in FIG. 1A) which is opposite to the first face. A first portion 60 is used to carry information related to the card assembly. First portion 60 is capable of receiving printed information on each of the faces of the paper or substrate surface and generally carrying information related to the card offering or the mail, such as account numbers, dial in information, user data and the like.

The first portion 60 may be selected from any suitable stock such as cellulosic based material including paper, card and tag stock, pressure sensitive material and the like. However, films, both plastic and metalized films are also suitable for use for the first portion. In an exemplary embodiment the material selected for the first portion ranges usually from 20 pound bond paper to 100 pound stock, typically tag or card stock. Generally, stock for the first portion is greater than 32 pound stock, but the invention is not so limited thereby. Where the first portion is a pressure sensitive material, film or metalized layer, a corresponding weight sheet is utilized in connection with the present assembly.

It should be understood that reference to the longitudinally extending side edges and transversely extending end edges includes both portions 60 and 70 with the understanding that each of the portions would have their own set of transversely extending end edges and longitudinally extending side edges. As such, reference to each end edge and sides is not regularly repeated in connection with the rest of the description provided herein.

The business form card assembly 10 of the present invention also has a second portion 70 which is formed of a material that is sufficient to die cut one or more removable elements 80 such as cards as provided in the illustrative embodiment. The card arrangement can also be a self laminating construction in which after a recipient adds some additional indicia such as a signature, the recipient folds over the adjoining portion which adheres to the first card via adhesive exposed by the liner removal or other activation creating a protected card enclosure.

It should be understood that the type, shape, number and arrangement of the removable elements is discretionary and any such configuration may be used depending on the needs of the end user or particular application for which the removable elements are intended. As indicated in the present illustration a side by side arrangement of two cards is provided, or the cards may be a self-laminating construction as provided above. The cards or removable elements may be disposed one on top of the other or only a single element may be present. While the card is generally considered to be a “wallet sized” card, one about the standard dimensions of a credit card, the card could also be larger such as to form an informational placard or alternatively could be much smaller such as useful in connection with a key tag or the like.

The material from which the second portion 70 is selected may include paper stock to which a plastic like film, such as a MYLAR® or polyethylene coating has been applied to one or both surfaces of the paper or a plastic or film material. In either event the thickness of the stock depends on the particular application of the end user and may range from 0.05 mil to 25 mils in thickness with about 1 to 3 mils being preferred. The width of the material may range from 0.001″ to about 5″ however, the material can have any approximate width, radius or the like depending on the configuration or geometric arrangement of the product and the pattern selected in connection with the manufacture of the business form card assembly.

The first portion 60 of the business form card assembly is joined to the second portion 70 of the assembly along line 90 which may or may not be concealed by the pattern of material that is applied in connection with creating the lay flat assembly 10 of the present invention. That is, if a transparent coating is applied, such as a clear silicone, the line of demarcation between the first and second portions would be visible. Alternatively, if a clear glassine material is selected the line would also be viewable to the naked eye.

As shown in FIG. 1, three patterns 100, 110 and 120 are used in connection with creating the leveling effect of the present invention. As depicted in FIG. 1, one pattern is applied adjacent or substantially adjacent to a transversely extending end edge 50. The second pattern 110 is applied over the area where the two portions 60 and 70 meet one another and in addition to leveling the particular construction second pattern 110 also serves to hold the two portions 60 and 70 together to form a substantially homogenous, or single planar assembly 10.

A third pattern 120 is provided adjacent or substantially adjacent to the other transversely extending end edge 40 to complete the depiction in FIG. 1 and to prevent the tail end of the assembly 10 from being at a level different from or lower than that of the rest of the assembly. While FIG. 1 depicts the first and third patterns 100 and 120 being adjacent the transversely extending edges, it should be understood that the patterns 100 and 120 may also be spaced from the edges 40 and 50 so as to run parallel or substantially parallel to the edges.

The patterns 100, 110 and 120 may be of the same thickness or varying in thickness if a strip of material is applied or alternatively differ in coating weights and thicknesses if a coating or ink is used. That is, if the first portion of the assembly has a thickness of 3 mils and the second portion of the assembly is 5 mils, a strip of material applied to the first portion should be for example 3 mils and the strip applied to the second portion 1 mil so that the total thickness through the area of the form and material is equal for both portions at 6 mils.

The patterns as used in FIG. 1, and in an exemplary embodiment are created through the use of continuous strips of material such as highly calendared paper, machine glazed paper, glassine or tape. It should be understood that instead of the pattern running adjacent the transversely extending edges that the patterns may also be applied along or adjacent or spaced from the longitudinally extending sides. In addition, the patterns of leveling aids may also be disposed so as to run diagonally between the transversely extending edges or longitudinally extending sides. Patterns can also be applied in combinations of parallel, diagonal, perpendicular and random arrangements so that the leveling effect is still achieved. Placement of the patterns is at the discretion of the manufacturer and in light of conditions or requirements of the end user.

The cards 80 as shown in FIG. 1 are depicted in a side by side arrangement and are typically created through the use of a die to form a series of cuts and ties, perforations, crush arrangements, laser perforating or cutting and are separated from the second portion by lines generally depicted by reference numeral 130. In addition to the use of dies to create the separation point between the removable element and the portion from which it is to be removed, the separation can also be created by laser perforating and cutting and the like. The cards 80 may be printed with similar indicia, complementary indicia, such as membership cards for a husband and wife, or may have completely unrelated indicia, such as different tickets for events.

Referring briefly to FIG. 1A, the obverse face of the form assembly 10 as depicted in FIG. 1 is shown and includes a removable pressure sensitive label 65 that may be supplemental to the removable elements 130 contained in the second portion of the form assembly 10.

It should be understood that significant portions of the description included above is applicable to the successive figures and is not necessarily repeated for the sake of brevity. One with skill in the art would recognize the transferability and juxtaposition of such elements in connection with the remaining portion of the specification.

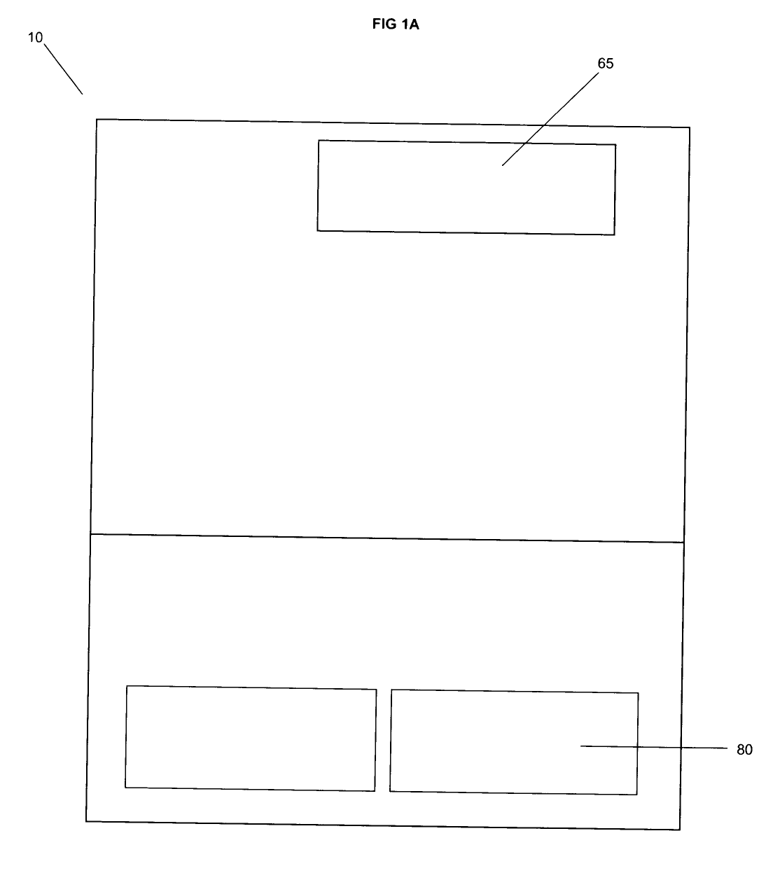

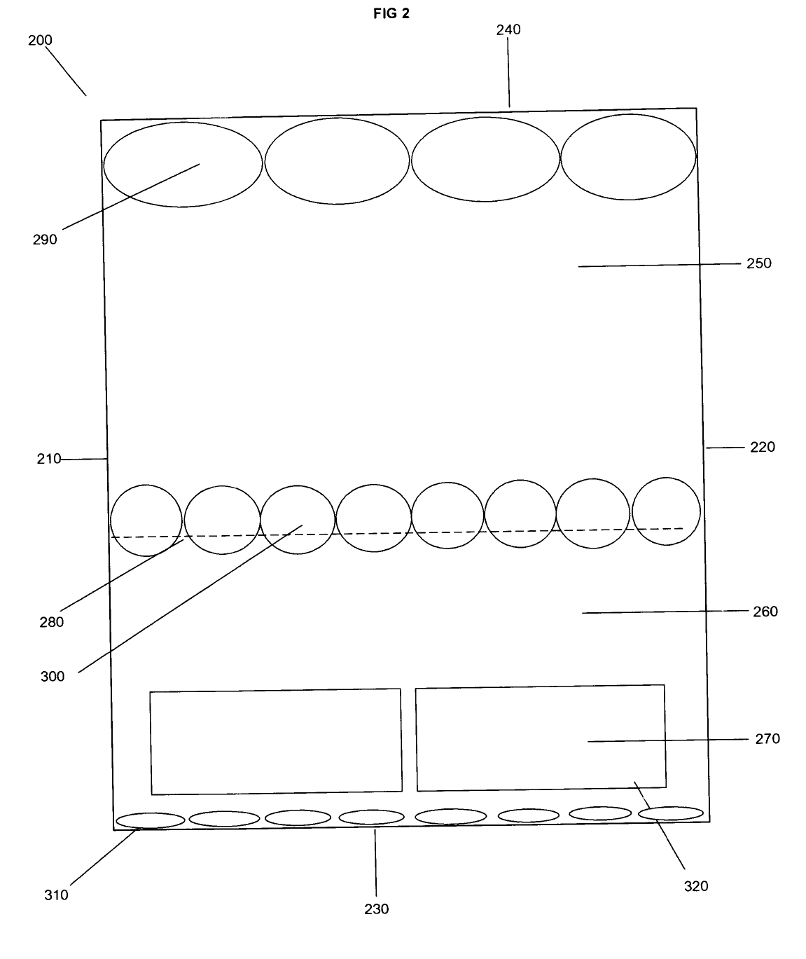

Turning now to FIG. 2, the business form card assembly is depicted by reference to numeral 200. The assembly 200 has first and second longitudinally extending side edges 210 and 220 and first and second transversely extending end edges 230 and 240. The assembly 200 is composed of first and second portions 250 and 260 which are laid next to one another at line 280. The assembly is shown with a two card arrangement 270 which are placed side by side and separable along line 320 through the use of die cuts, perforation, crush zones or the like.

Die cutting and perforating are typically done with blades, lasers or dies that form a series of cuts and ties that will correspond to the area being die cut in the card. In order to create a crush zone, a wax based or starch based coating is applied over the area of the cards and then a crushing die is brought down into engagement with the area of the coating corresponding to the cards. Then by bending the card carrying material the combination of the coating along with the crush die enable the cards edges to fracture and to separate from the card carrying material.

FIG. 2 is illustrated with a plurality of patterns 290, 300 and 310 which serve to create the lay flat assembly 200 of the present invention. Each of patterns 290 and 310 are disposed adjacent the transversely extending end edges of the form. As indicated previously in the discussion around FIG. 1, the patterns may be disposed in any other number of arrangements depending on the particular needs of the product as required by the end user of the assembly 200. Pattern 300 is disposed over the line 280 where the first and second portions of the form assembly meet one another at 280.

FIG. 2 depicts an alternate arrangement of the types of patterns that may be used in connection with the present invention. FIG. 2 shows several different types of geometric shapes from round to ovoid to elliptical. The patterns as shown are continuous, but it should be understood that the patterns may be irregular or composed of many different shapes or the patterns may be interspersed with differential elements such that the patterns appear irregular or non-repeating or segmented as opposed to continuous.

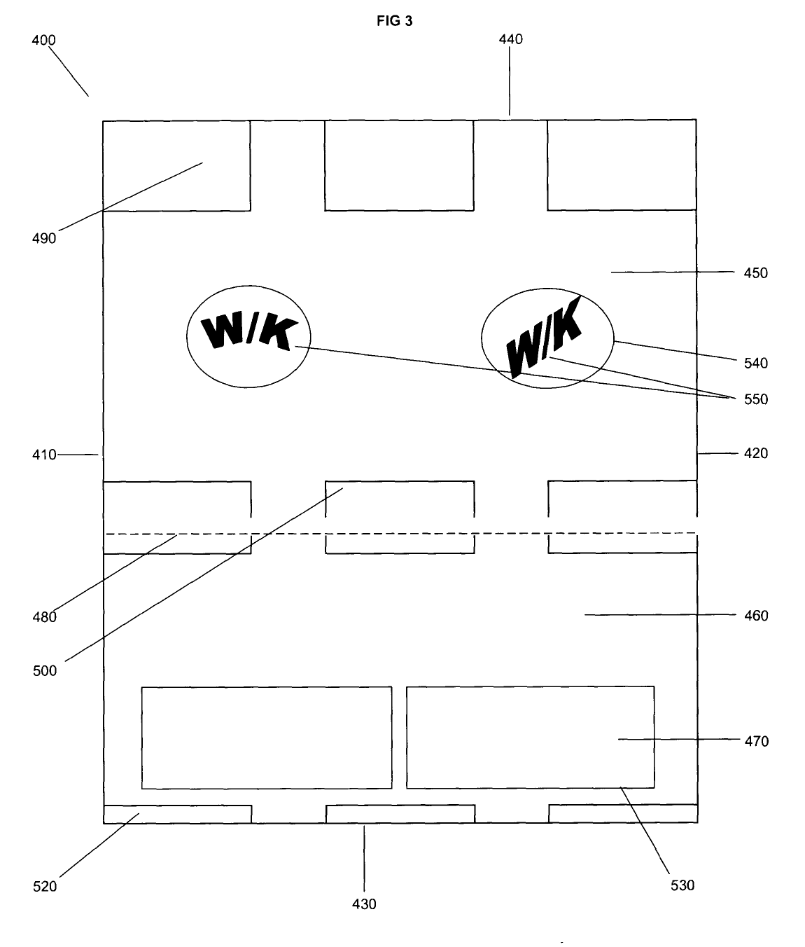

Now turning to FIG. 3 a still further depiction of the present invention is provided and the business form card assembly is generally referred to by reference to numeral 400. The form assembly 400 is provided with first and second longitudinally extending side edges 410 and 420 and first and second transversely extending end edges 430 and 440. The assembly 400 has first and second portions 450 and 460. The first portion 450 is capable of receiving printed information on each of the faces of the paper surface or substrate and generally carrying information related to the card offering or the mailing.

Cards 470 are illustrated in a side by side configuration and are separable from the substrate through perforation lines, die cuts, crush patterns and the like illustrated by reference to numeral 530. Cards 470 may be printed with any information relating to the particular transaction that is under contemplation and the indicia may be identical, or dissimilar depending on the needs of the particular end user or customer for whom the business form card assembly 400 is being produced.

FIG. 3 depicts a plurality of patterns 490, 500 and 520 that are shown as segmented blocks. The material that can be used to form the patterns may be selected from a group including glassine, machine glazed paper, highly calendared paper, coatings, inks and combinations thereof. The segmented patterns illustrated in FIG. 3 may be placed in alignment with each other or may be prepared in a staggered or other randomized pattern.

FIG. 3 also shows further patterns 540 which are illustrated as ovoid in shape. Such additional patterns may be used in connection with lighter stock material such as a 20 pound bond paper stock. The additional pattern may prevent the substrate from sagging in the area not covered by other patterns. In addition, the pattern 540 is also shown printed or imaged with indicia 550 which may supplement a particular marketing campaign or provide other information for the end user or the manufacturer. The additional pattern may be formed from similar materials as discussed above or may be different from the other patterns. For example, if patterns 490, 500 and 520 are composed of a machine glazed paper, pattern 540 may be composed of a coating or printed ink.

Coatings useable in connection with this invention include silicone, wax and starch based coatings and other release materials that create a differential or roughened surface and which can be applied in varying thicknesses so as to accommodate for the differential in thickness created by the removable element portion, card products or joining segment, pattern 500 as shown in FIG. 3.

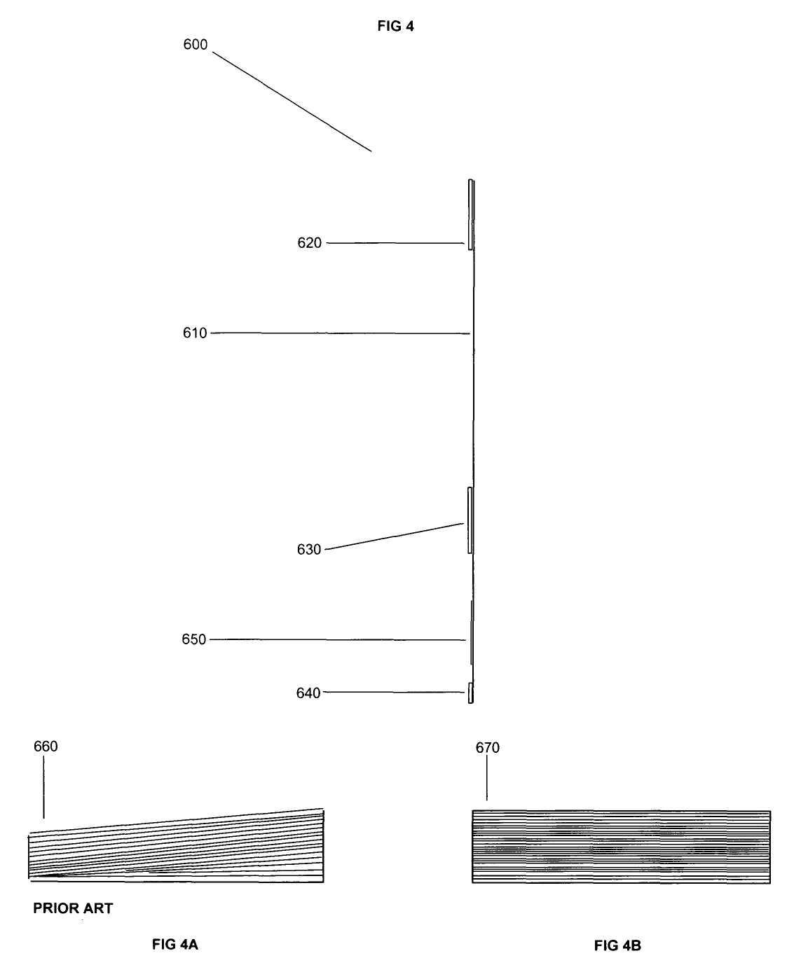

FIG. 4 represents a side view of the present invention depicting business form assembly generally by reference to numeral 600. Three patterns 620, 630 and 640 are shown on the substrate 610. Pattern 630 is used to hold the two portions (as shown in FIGS. 1-3) together. Removable elements 650 are also shown in position on the substrate 610.

FIGS. 4A and 4B show the difference between the prior art (FIG. 4A) which does not have the benefit of the leveling aids and that of the present invention (FIG. 4B) which is provided with a series of leveling aids in order to create a lay flat stack that maintains its relatively square, cube or rectangular shape.

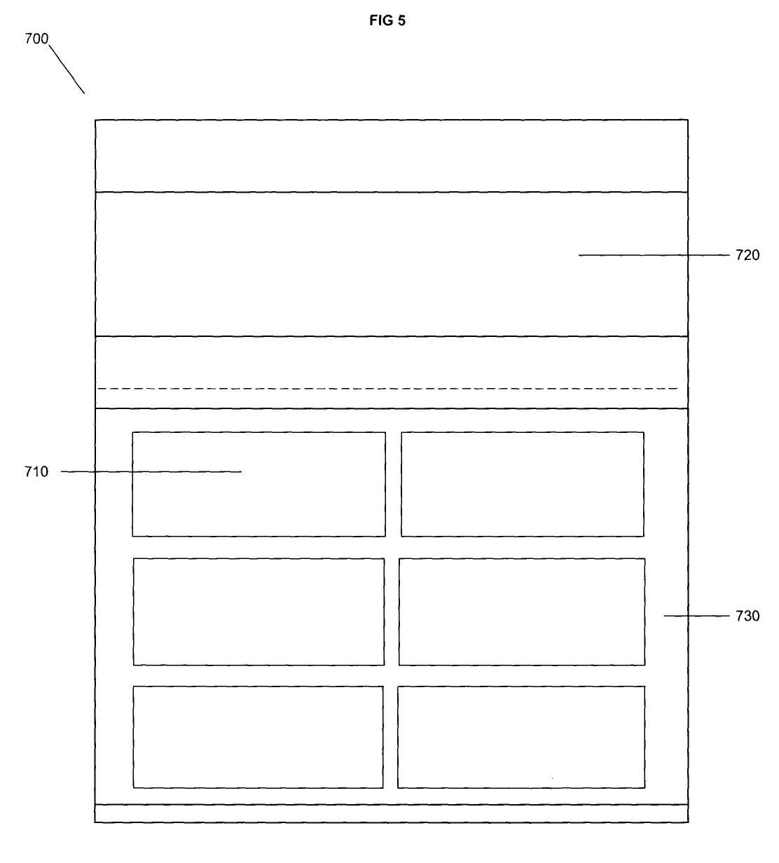

Turning to FIG. 5, the business form card assembly of the present invention is shown generally by reference to numeral 700. The business form card assembly is illustrated with a multiple card embodiment and with the first portion 720 and second portion 730 in differing proportional amounts.

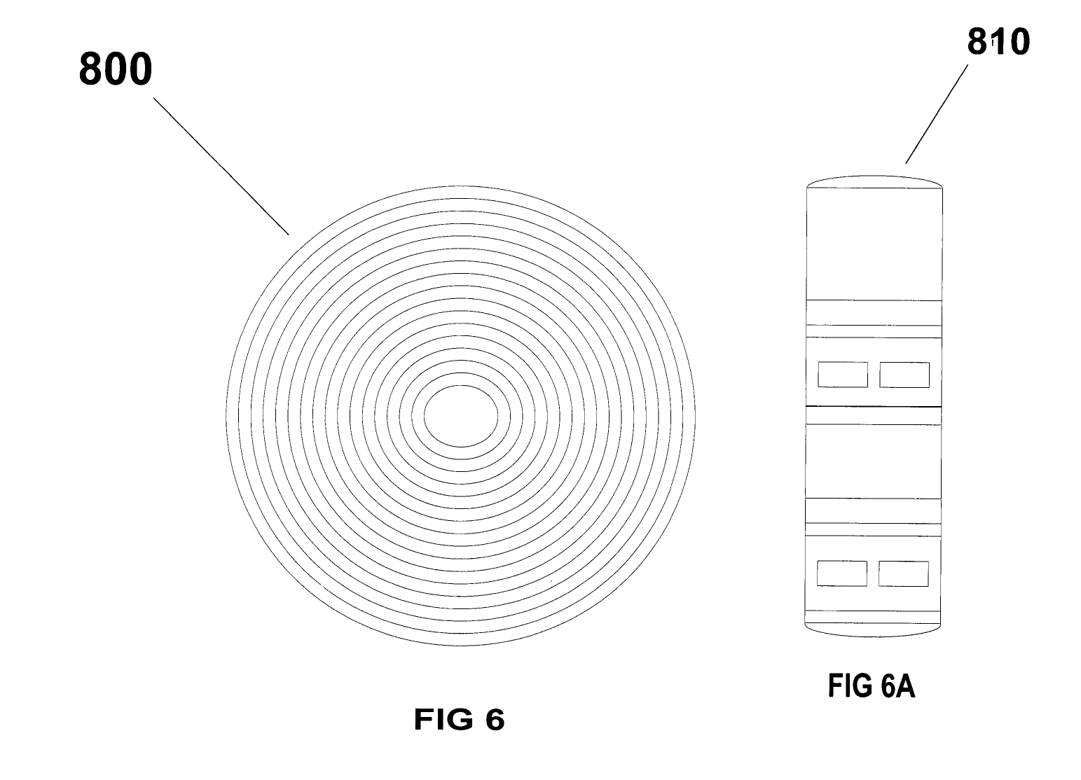

FIG. 6 shows the business form card assembly of the present invention in a rolled or continuous configuration. Surprisingly, the lay flat card of the present invention can be wound into a roll for continuous feeding operations. The leveling aids of the present invention enable the product to essentially be wound substantially flat as would be the case with uncoated paper or other substrates.

FIG. 6A provides a cut away segment of the form assembly provided in FIG. 6 and illustrates the patterns used as leveling aids for the invention as well as the position of the removable cards.

It has also been unexpectedly found that through the use of the materials described above, glassine, machine glazed papers, starch and silicone based coatings, that the business form card assemblies when placed in a stack do not stick to one another and hence do not encounter the problem attributed to static build up of the form assembly. That is the materials reduce the surface affinity between forms, enabling the forms to release from one another in the stack. With respect to the coatings and inks that may be applied the surface of the coatings may have a roughened or discontinuous surface so as to facilitate the separation of sheets from one another. In addition, it is believed that the materials and coatings as contemplated by the present invention also facilitate the feeding of the sheet into the printer or other processing apparatus as well as the traversing of the equipment.

The present invention is a highly efficient business form card combination that is both economical to manufacture and overcomes many of the aforementioned difficulties encountered by other prior art form/card constructions. The present business form card construction does not suffer from such problems as static, pad lean or slope, feeding difficulties and the like.

One of the most important things with respect to new product innovations is the need to effectively market and communicate the new product to potential customers and end users of the product. Such marketing typically includes the creation of marketing collateral associated with the features of the business form card assembly and then selling the assembly in connection with that marketing collateral and then distributing the business form card assembly to potential end users and customers. Customers can include distributors of such products as well as office supply stores, retail and warehouse outlets that may not be end users, but may repackage and resell the products to end users or third parties.

Marketing collateral as used herein includes the use of scripted or prepared material that are distributed through audio and visual communication mediums, over a global communication network, through printed mediums such as newspapers, trade publications, magazines, fliers, handouts and the like.

The lay flat configuration of the present invention also enables the form assembly to be fed through the processing or printing equipment in a landscape or long side first format thus reducing print head wear and expediting processing of the form assemblies with removable elements.

It will thus be seen according to the present invention a highly advantageous business form card configuration has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business form, comprising;
a first substrate having a first property and having first and second longitudinal side edges and first and second transverse end edges;
a second substrate having a second property, said second substrate being joined to said first substrate along one of said side or end edges;
at least one element removable from one of said first and second substrates;
a plurality of patterns disposed between one of said sides or end edges of at least one of said first and second substrates, said plurality of patterns being applied to said at least one of said first and second substrates and said plurality of patterns spaced from one another;
at least one of said plurality of patterns connecting said first substrate to said second substrate; and
wherein said plurality of patterns with said first and second substrates create a substantially planar business form assembly having at least one removable element.

2. A business form as recited in claim 1, wherein said patterns are composed of continuous, discontinuous, segmented, uninterrupted arrangement and combinations thereof.

3. A business form as recited in claim 2, wherein said patterns are stripes, strips, dots, geometric shapes, printed designs and combinations thereof.

4. A business form as recited in claim 1, wherein said first and second properties are composition.

5. A business form as recited in claim 4, wherein said composition is selected from a group including cellulosic, plastics, metal based films and combinations thereof.

6. A business form as recited in claim 1, wherein the spacing between said plurality of patterns extends less than an area between one of said side edges or said end edges.

7. A business form as recited in claim 1, wherein a plurality of said planar business form assemblies when placed in a stack will have a substantially square, cube or rectangular configuration.

8. A business form as recited in claim 1, wherein said plurality of patterns are selected from a group including glassine, machine glazed paper, highly calendared paper, starch or wax based coatings, silicone coatings and combinations thereof.

9. A business form as recited in claim 8, wherein the coatings have a roughened surface.

10. A business form as recited in claim 1, wherein each of said first and substrates has at least one pattern disposed thereon.

11. A business form as recited in claim 1, wherein said plurality of patterns may be provided with indicia.

12. A business form as recited in claim 1, wherein said plurality of patterns decrease surface affinity between said planar business form card assemblies.

13. A business form as recited in claim 1, wherein said property is thickness.

14. A business form as recited in claim 1, wherein said element removable from the form assembly is selected from a group including cards, tags, coins, chips, labels and combinations thereof.

15. A business form as recited in claim 1, wherein said element is a self laminating card.

16. A method of communicating the benefits of a business form assembly having a removable element, comprising the steps of;
producing a number of business form assemblies having at least one removable element, said assemblies having at least first and second portions, with said first and second portions having at least an area of different thickness from one another; one of said first and second portions having at least one removable element that creates at least a portion of said different thickness and each of said first and second portions having a pattern of material disposed thereon to create a substantially planar business form assembly with said removable element so that when said assemblies are placed in a stack with other business form assemblies with said at least one removable element said stack will have a square, cube or rectangular configuration;
creating marketing collateral with respect to using said business form assemblies;
selling said business form assemblies in connection with said marketing collateral to customers or end users; and
distributing said business form assemblies with said removable element.

17. A method as recited in claim 16, wherein said customers are selected from a group including distributors, office supply stores, retail outlets, warehouse stores and combinations thereof.

18. A method as recited in claim 16, wherein said removable element is selected from a group including cards, tags, coins, chips, labels and combinations thereof.

19. A method as recited in claim 16, wherein said marketing collateral includes information disseminated through audio, audio visual, print, global communications network and combinations thereof.

20. A business form assembly, comprising;
a substrate having first and second portions distinct from one another, said first and second portions are joined one to another through a first pattern of material applied along an edge of each of said first and second portions;
one of said first and second portions having at least a second pattern of material disposed thereon spaced from said first pattern;
at least one removable element contained within one of said first and second portions, said removable element having a thickness different than at least one of said first and second portions;
said first and second patterns with said removable element cooperating to form a substantially coplanar assembly;
said first and second portions with said removable element and said first and second patterns of material are connected to additional business form assemblies to create a continuous business form arrangement; and
wherein said continuous business form arrangement is wound on itself to form a roll of business form assemblies with removable elements.

21. A business form assembly as recited in claim 20, wherein said first and second patterns of material are selected from a group including glassine, machine glazed paper, highly calendared paper, wax or starch based coatings, silicone coatings, ink and combinations thereof.

22. A business form assembly as recited in claim 20, wherein said at least one of said first and second patterns of material are provided with indicia.

23. A business form assembly as recited in claim 20, wherein said removable element is selected from a group including cards, tags, coins, chips, labels and combinations thereof.

24. A stack of business form assemblies having at least one removable element, comprising;
a removable element, said removable element having a different thickness that the business form assembly;
a plurality of business form assemblies, each of said assemblies having a first and second portion joined to one another by a first pattern of material and one of said first and second portions having at least a second pattern of material;
said first and second patterns of material along with said at least one removable element cooperate to create a substantially planar assembly; and
wherein said plurality of business form assemblies forms a square, cube or rectangular shaped stack ranging from 10 to about 10,000 assemblies.

25. A stack of business form assemblies as recited in claim 24, wherein said material is selected from a group including glassine, machine glazed paper, highly calendared paper, wax or starch based coatings, silicone and combinations thereof.

26. A stack of business form assemblies as recited in claim 24, wherein said material may be provided in a format selected from a group including continuous, discontinuous, segmented, regular, irregular and combinations thereof.

27. A stack of business form assemblies as recited in claim 24, wherein said material creates reduced surface affinity between successive form assemblies.

28. A stack of business form assemblies as recited in claim 24, wherein said removable element is selected from a group including cards, tags, coins, chips, labels and combinations thereof.

29. A method if using a business form assembly, comprising the steps of;
providing a series of business form assemblies, each of said assemblies having discrete first and second portions with said first and second portions joined to one another along an end edge, at least one of said first and second portions provided with a removable element having a thickness different than that of at least one of said first and second portions; and each of said first and second portions provided with patterns of material to offset the thickness of said removable element and said patterns of material reducing surface affinity between successive business form assemblies;
stacking said business form assemblies for processing through a printer or other handling equipment; and
feeding said business form assemblies in a landscape format through said printer or other handling equipment.

30. A method as recited in claim 29, wherein said removable element is selected from a group including cards, tags, coins, chips, labels and combinations thereof.

31. A method as recited in claim 29, wherein said first and second pattern of material is selected from a group including glassine, machine glazed paper, highly calendared paper, wax or starch based coatings, silicone and combinations thereof.

32. A method as recited in claim 29, wherein said patterns may be provided in a format selected from a group including continuous, discontinuous, segmented, regular, irregular and combinations thereof.
